(19) United States
(12) Patent Application Publication
(10) Pub. No.: US 2011/0122058 A1
(43) Pub. Date: May 26, 2011

(54) Inline control system for therapeutic pad

(76) Inventor: Louise Mohn, London (GB)

(21) Appl. No.: 12/592,493

(22) Filed: Nov. 25, 2009

(51) Int. Cl. G09G 5/00

(52) U.S. Cl. 345/156

(57) ABSTRACT

A controller for use in a therapeutic system having a console disposed in a first housing and a physically separate pad. The controller includes a second housing physically separate from the console and the pad; a processor disposed within the housing and electrically coupled to the console and the pad; a storage medium accessible by the processor and mounted within the second housing; software stored on the storage medium for execution by the processor; a switch coupled to the processor; and a display coupled to the processor. In the illustrative embodiment, the invention further includes a second processor disposed within the housing and electrically coupled to the console and the pad. In a specific implementation, the controller includes software for applying stimulation current to the pad and for regulating heat current applied to the pad. The software includes code for sensing temperature from the pad and for adjusting current to the pad in response to the sensed temperature at the pad and a reference temperature data from the console. The invention enables a thermostimulation system comprising a console disposed in a first housing; a plurality of thermostimulation pads; and a plurality of the inline controllers electrically coupled between the console and a respective one of the pads.

### BACKGROUND OF THE INVENTION

1. Field of the Invention

The present invention relates to therapeutic systems. More specifically, the present invention relates to systems and methods for regulating energy applied to therapeutic pads.

2. Description of the Related Art

Therapeutic pads are used in a variety of treatment modalities currently known in the art including electrical stimulation, heat therapy and thermostimulation. Electrical stimulation involves the application of an electrical current to a single muscle or a group of muscles. The resulting contraction can produce a variety of effects from strengthening injured muscles and reducing oedema to relieving pain and promoting healing. Many electrical stimulation systems are limited to two to four channels and therefore allow only two to four pads to be applied to a patient. The pads are often small and typically powered with a battery. This results in the application of a small amount of power and a low treatment depth of the resulting electric field. The shallow depth of the electric field generated by conventional electrical stimulation systems limits performance and patient benefit. Some systems have attempted to address this limitation by applying more current, often from a line or main supply source. However, the small size of conventional electrical stimulation pads is such that on the application of larger amounts of power, i.e. the use of higher currents, patients often report the experience of pain or discomfort.

Heat therapy or thermal stimulation itself is very useful as it has a number of effects such as relaxation of muscle spasm and increased blood flow that promotes healing. However, combination therapy, i.e. the synergistic use of other modalities such as massage, ultrasound and/or electrical stimulation has been found to be more effective than heat therapy alone.

Thermostimulation is one such combination therapy that involves the use of heat therapy and electrical stimulation simultaneously. With thermostimulation, the healing benefits of heat are provided along with the strengthening, toning, pain relieving and healing benefits of electrical stimulation. Moreover, the application of heat has been found effective in that it allows the patient to tolerate higher currents. This yields higher electric fields strengths, greater depths of penetration and therefore, more positive results than could be achieved with electrical stimulation without heat.

Unfortunately, conventional thermostimulation pads do not include heat sensors. As a consequence, the associated control systems and protocols must be limited to protect the patient from excessive and deleterious high temperatures. Moreover, without temperature sensing and feedback, more sophisticated treatment modalities are not possible with convention thermostimulation pads. Copending U.S. patent application entitled THERMOSTIMULATION PAD WITH INTEGRATED TEMPERATURE SENSOR, filed ______ by L. Mohn, Ser. No. ______ (Atty. Docket No. Luzmon-6) the teachings of which are incorporated herein by reference, discloses and claims a novel and advantageous thermostimulation pad design with an integrated temperature sensor. The incorporation of a temperature sensor enables more accurate temperature control and new treatment modalities as well. However, no mechanism is provided for individual control of each pad.

Accordingly, a need exists in the art for a system for controlling therapeutic pads to enable individual, yet accurate control thereof.

### SUMMARY OF THE INVENTION

The need in the art is addressed by the system and method of the present invention. Generally, the invention includes a controller for use in a therapeutic system having a console disposed in a first housing and a physically separate pad. The controller includes a second housing physically separate from the console and the pad; a processor disposed within the housing and electrically coupled to the console and the pad; a storage medium accessible by the processor and mounted within the second housing; software stored on the storage medium for execution by the processor; a switch coupled to the processor; and a display coupled to the processor.

In the illustrative embodiment, the invention further includes a second processor disposed within the housing and electrically coupled to the console and the pad. In a specific implementation, the controller includes software for applying a stimulation current to the pad and for regulating heat current applied to the pad. The software includes code for sensing temperature from the pad and for adjusting current to the pad in response to the sensed temperature at the pad and a reference temperature data from the console.

The invention enables a thermostimulation system comprising a console disposed in a first housing; a plurality of thermostimulation pads; and a plurality of the inline controllers electrically coupled between the console and a respective one of the pads.

The invention also enables novel modes of operation including a method for regulating heat current to a therapeutic pad including the steps of: providing an inline controller between a console and the pad, the controller having: a processor disposed within a second housing and electrically coupled to the console and the pad; a storage medium accessible by the processor and mounted within the second housing; and software stored on the storage medium for execution by the processor; providing a temperature or heat level setting at the console; and regulating heat current to the pad via the inline controller.

### BRIEF DESCRIPTION OF THE DRAWINGS

FIG. 1 is a perspective view of a typical thermostimulation system implemented in accordance with conventional teachings.

FIG. 2 is a simplified block diagram of an illustrative conventional electrical system for the typical thermostimulation system of FIG. 1.

FIG. 3 is a simplified perspective view of a thermostimulation system implemented in accordance with an illustrative embodiment of the present teachings.

FIG. 4 is a perspective side view of the inline control system of FIG. 4 fully assembled.

FIG. 5 is a perspective side view of the inline control system of FIG. 4 disassembled.

FIG. 6 is a sectional side view of the inline control system of FIG. 4 fully assembled.

FIG. 7 below is an electrical block diagram of the thermostimulation system including the inline control system elements.

FIG. 8 is a flow diagram of the firmware executed by the main microcontroller of FIG. 7.

FIG. 9 is a flow diagram of the firmware executed by the safety microcontroller of FIG. 7.

FIG. 10 is a flow diagram of the firmware executed by the main and safety microcontrollers of FIG. 7 in a self-test mode of operation in accordance with the present teachings.

### DESCRIPTION OF THE INVENTION

Illustrative embodiments and exemplary applications will now be described with reference to the accompanying drawings to disclose the advantageous teachings of the present invention.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

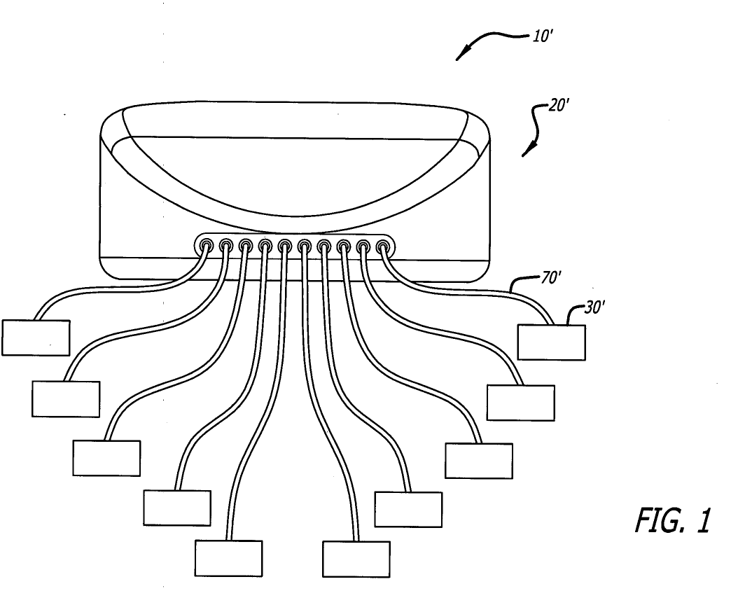

FIG. 1 is a perspective view of a typical thermostimulation system implemented in accordance with conventional teachings. The system 10′ includes a conventional thermostimulation console 20′ and a plurality of thermostimulation pads 30′. The console may be of the type that may be purchased from Ross Estetica of Barcelona Spain. (See http://corporativa.ross.es/rosseng/ross/indexross.htm.) Note that in accordance with conventional teachings, the electrical stimulation and heat currents are supplied to the pads by the console with no feedback with respect to the temperature of at the pad. As mentioned above, this limits the performance capability of the overall system and the number of unique treatment modalities enabled by the system.

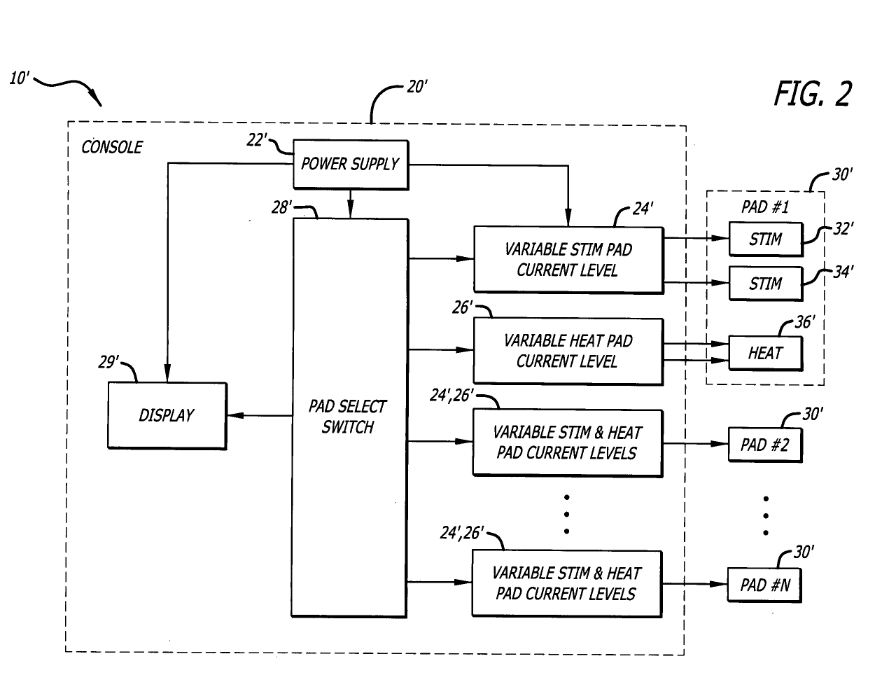

FIG. 2 is a simplified block diagram of an illustrative conventional electrical system for the typical thermostimulation system of FIG. 1. The system 10′ includes a power supply 22′ disposed in the console 20′ that provides current for the pads 30′ through a set of attenuators 24′ and 26′ for each pad 30′. The first attenuator 24′ regulates current to a set of stimulation contacts 32 and 34 provided on an exposed surface of the pad 30′ and the second attenuator 26′ regulates current to a heating coil 36′ embedded within the pad. A pad select switch 28′ provides an enable signal for each attenuator under operator control and outputs the setting level status to the operator via a display 29′. Note that the system 10′ only sets the heat and stimulation current levels. As noted above, as no temperature sensor is provided in the conventional pad 30′, no pad temperature regulation or control is possible. In addition, it should also be noted that the electrical arrangement of FIG. 2 is provided for illustration only. Other electrical arrangements may be known and used in the art.

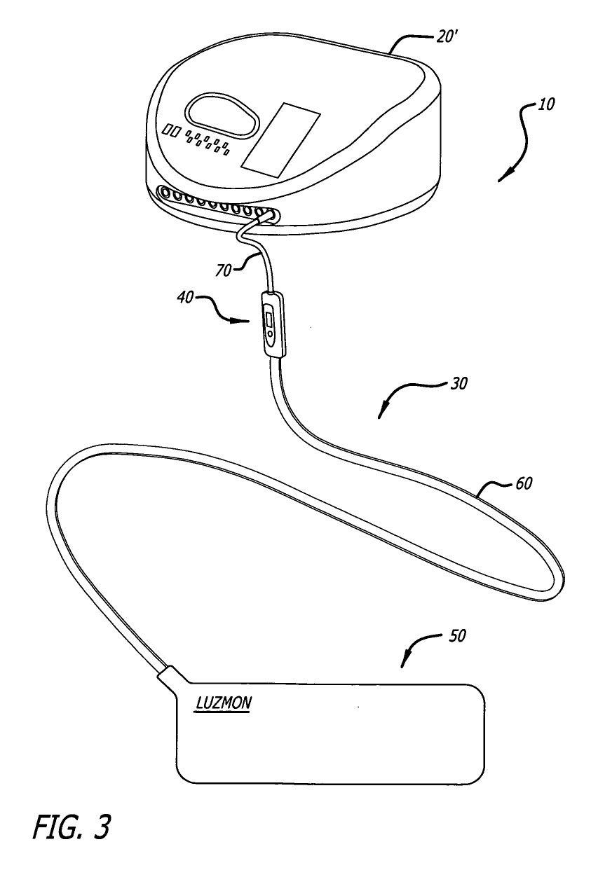

FIG. 3 is a simplified perspective view of a thermostimulation system implemented in accordance with an illustrative embodiment of the present teachings. As shown in FIG. 3, the system 10 includes a conventional thermostimulation console 20′ with, in accordance with the present teachings, a plurality of novel thermostimulation pad assemblies 30 electrically coupled thereto. Each pad assembly 30 includes a novel inline control system 40 and an associated multilayer injection molded dual function (heat and stimulation) pad 50 of unique design and construction with integrated sensor in accordance with the present teachings.

In the best mode, the pads 50 are implemented in accordance with the teachings of the above-noted copending U.S. patent application entitled THERMOSTIMULATION PAD WITH INTEGRATED TEMPERATURE SENSOR, filed ______ by L. Mohn, Ser. No. ______ (Atty. Docket No. Luzmon-6) the teachings of which have been incorporated herein by reference.

As illustrated in FIG. 3, each inline control system 40 is connected to an associated pad 50 via a cable 60.

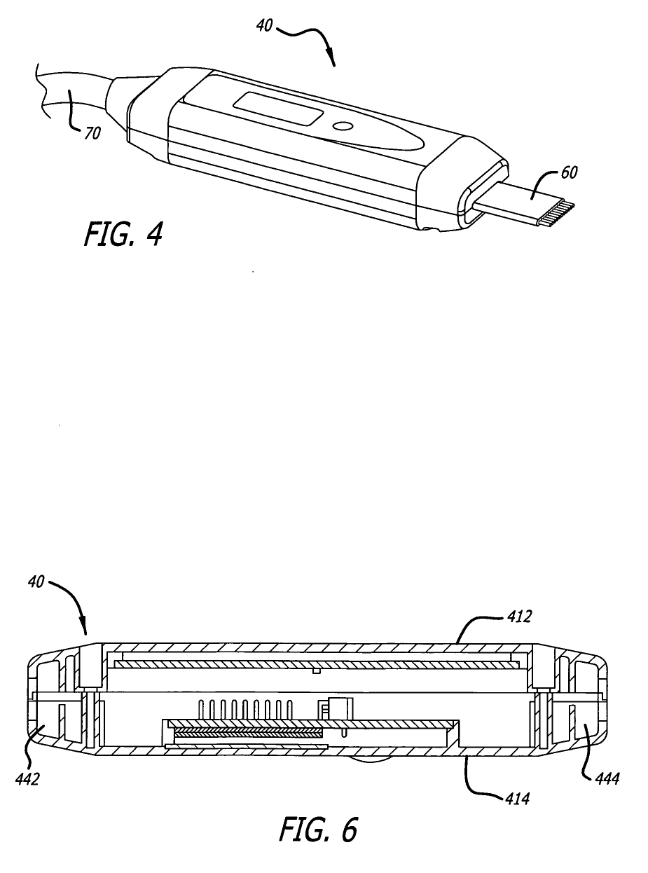

FIG. 4 is a perspective side view of the inline control system 40 fully assembled.

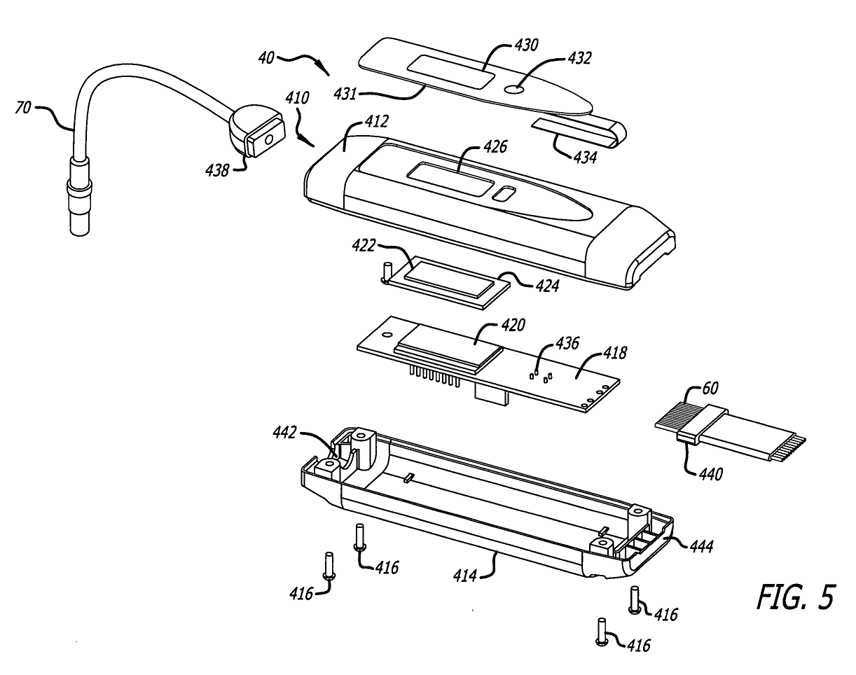

FIG. 5 is a perspective side view of the inline control system 40 of FIG. 4 disassembled. As shown in FIG. 5, the control system 40 includes a two part injected molded ABS plastic housing 410 with an upper casing 412 and a lower casing 414. The housing 410 is adapted to retain a multilayer printed circuit board 418 on which an integrated circuit 420 is disposed. A microprocessor (not shown) is provided by the integrated circuit 420. Numerous additional electrical components are mounted onto the printed circuit board 418 along with a liquid crystal display (LCD) 422.

As shown in FIG. 5, the LCD 422 is protected by a small Perspex window 430. In the best mode, the LCD display 422 shows both the target and actual temperatures for the associated pad. The window 430 seats within an aperture 426 in the upper casing 412 of the housing 410. A plate 431, contoured to fit within a depression on the upper surface of the upper casing 412, is fitted with a manual override switch 432. The switch 432 connects to the control circuitry on the printed circuit board 418 via a flexible wire 434 and pins 436. In the illustrative embodiment, the switch is used to enable the user to confirm when the user wants to heat a pad 50 above 38 degrees Celsius.

As illustrated in FIG. 5, the round cable 70 from the console 20 enters the top of the control system 40 and is held in place by a grommet 438. The cable 60 enters the system 40 from the bottom and is held in place by a second grommet 440 that is also used as a strain relief device at the cable termination with the pad. The second grommet 440 is a two-section grommet which captures the cable as it enters the system 40. The system 40 is then held together by four screws 416. As illustrated in the sectional side view of FIG. 6, when secured together, the upper and lower casings 412 and 414 provide first and second chambers for seating the second grommet 438 and the third grommet 440.

As mentioned above, each pad has a heating element, two RTD sensors (one for active temperature control and another for backup) and two stimulation pads that make electrical contact with the user.

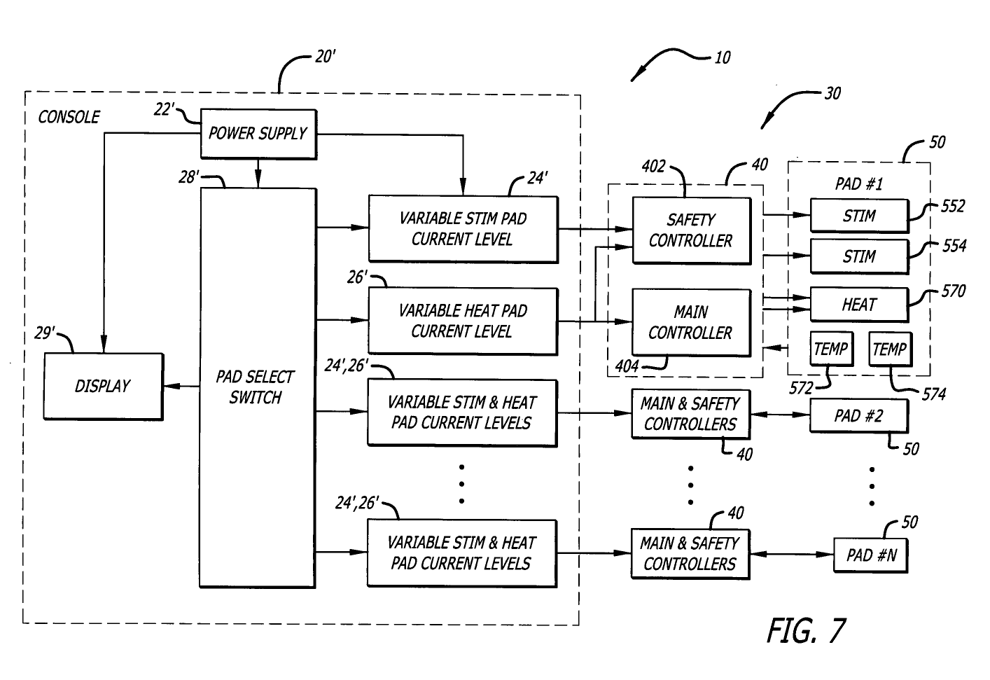

FIG. 7 below is an electrical block diagram of the thermostimulation system 10 including the inline control system elements 40. The circuitry of the control system 40 is powered by the heating current from the console 20. The control system 40 provides intelligent operation for the pad 50, monitoring the current going to both electrostimulation pads 552 and 554 and the heating element 570. These currents can be set at different levels by the control system 40 depending on the program selected or manually adjusted after a program is selected. The conventional console 20 does not allow for the temperature to be measured or monitored but instead typically has a heating current level setting described as a “heating percentage”. Since a regulation or control functionality is not conventionally available, the current sent to the pads could allow them to heat to more than 42 degrees Celsius, a level which is outside of safe levels and the requirements set by the EN60601-2-35 standard.

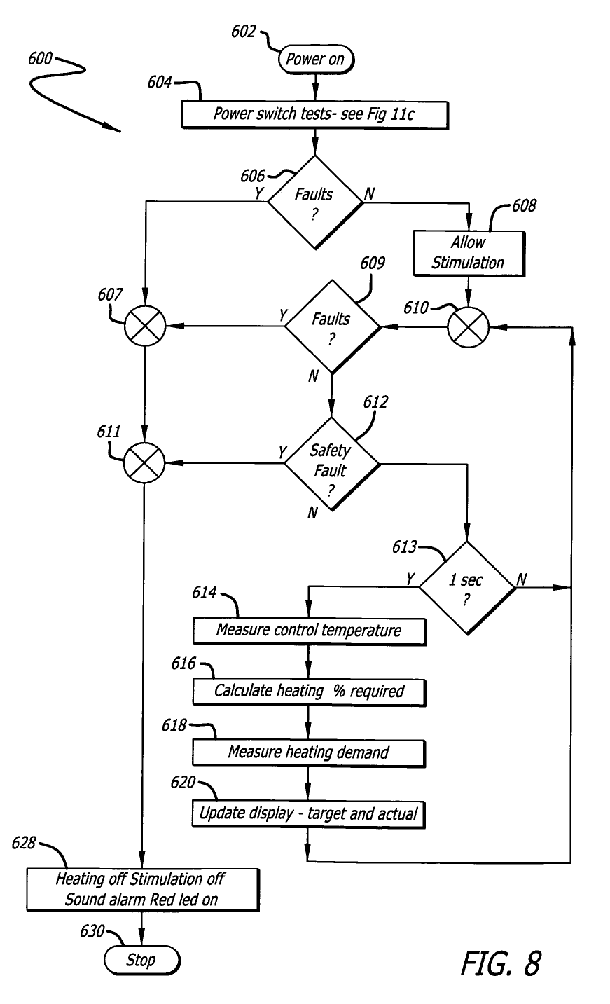

As illustrated in FIG. 7, in the illustrative embodiment, each control system 40 is implemented with first and second microcontrollers (implemented in the best mode with microprocessors) 404 and 402, that control and interrupt the current to the stimulation electrodes 552 and 554 and the heating element 570 of FIG. 7 respectively. The first controller 404 serves as a main controller and the second controller 402 serves as a safety controller. As discussed more fully below, each microcontroller runs unique software (i.e. firmware) stored on a tangible medium, such as an electrically erasable programmable read only memory (EPROM), in the integrated circuit 420 of FIG. 8.

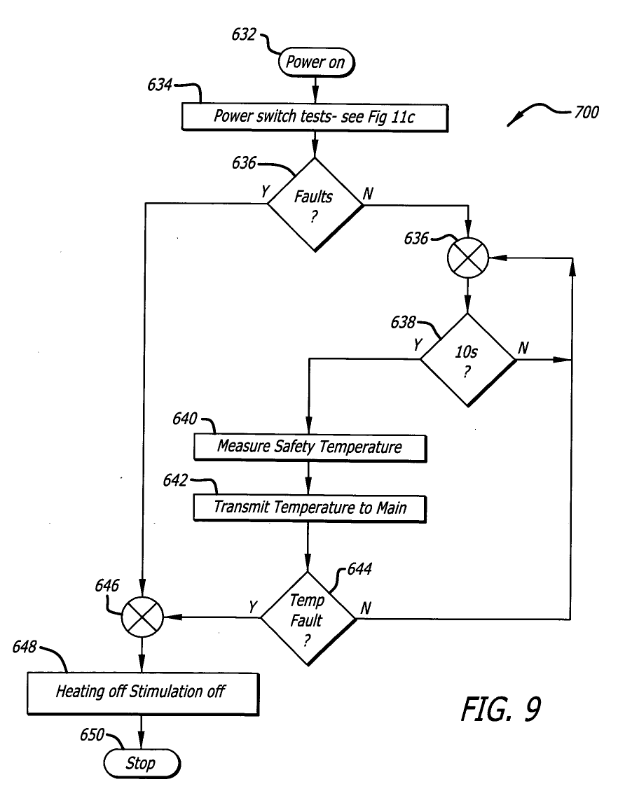

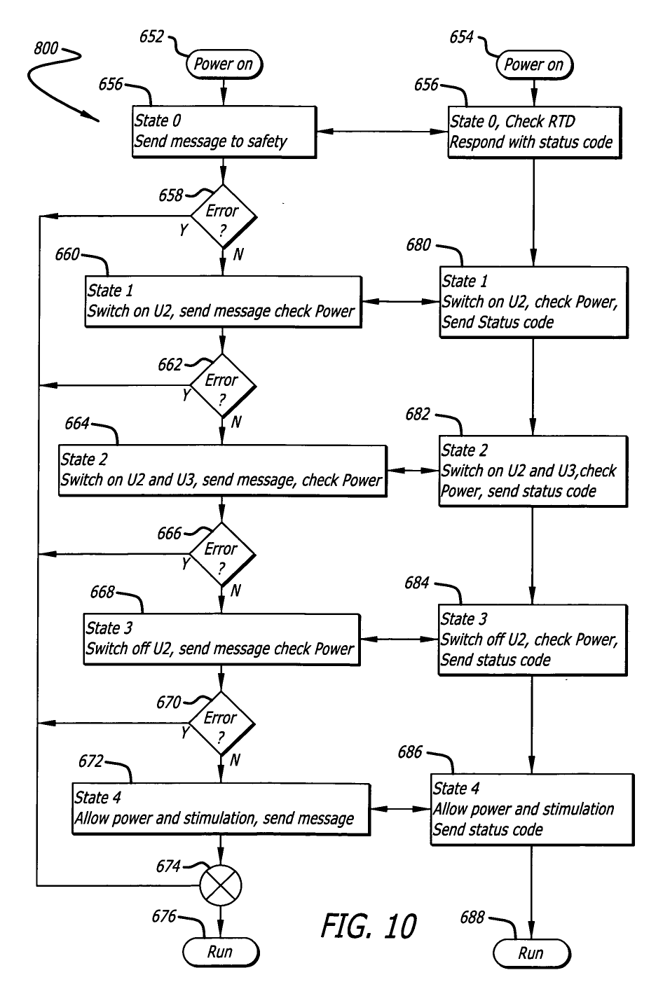

FIGS. 8-10 are flow diagrams of the firmware executed by the microprocessors in accordance with an illustrative embodiment of the present teachings. FIG. 8 is a flow diagram of the firmware executed by the main microcontroller 404 of FIG. 7. FIG. 9 is a flow diagram of the firmware executed by the safety microcontroller 402 of FIG. 7. FIG. 10 is a flow diagram of the firmware executed by the main and safety microcontrollers of FIG. 7 for a self-test mode of operation. Both microcontrollers monitor the heating power control devices to determine whether they perform the correct on-off switching action or have failed as a short circuit or an open circuit. During the power up stage, the MMC and SMC communicate using an asynchronous communications link. In the illustrative embodiment, the microprocessors communicate with each other every second to pass status information using an I2C serial interface.

The MMC 404 sends messages to the SMC to tell it which test is being performed and then the SMC 402 sends the results of the tests at each stage. Only if all the stages pass with no failures is power applied to the heating circuit 570 in the pad.

During power up (602), or at a power setting greater than five percent (5%) of maximum, the main microcontroller (MMC) 404 performs a self-test (604) to detect any possible failures and then communicates with the safety microcontroller (SMC) 402. As illustrated in FIG. 10, the self-tests are synchronized such that all hardware functionality is tested before enabling heating power to the patient.

The pad assembly, including the electronics, is calibrated. Calibration information is stored in an EPROM (not shown) within the MMC 404. In order that the SMC 402 can accurately determine whether the associated regulated pad is overheating, a calibrated maximum temperature value is passed from the MMC to the SMC during the power up procedure.

After checking for faults (606) the MMC 404 enables stimulation (608) and monitors the percentage power setting of the console 20 (see steps 614-616). This is used to set a target temperature for the pad. This target temperature is displayed on the LCD 422. Should the target temperature be greater than 38° C. the software 600 requires the operator to press the front panel switch on the console 20 to confirm the intention to set a higher temperature. Table I below lists illustrative target temperatures corresponding to various power levels.

TABLE I

| | Target |
|---|---|
| Power setting % | Temperature |
| 5-20 | 36 |
| 20-30 | 37 |
| 30-40 | 38 |
| 40-50 | 39 |
| 50-60 | 40 |
| 60-100 | 41 |

In the illustrative embodiment, a reduction in target temperature would not have to be confirmed.

During the pre-heating stage of a procedure the CTEMS unit will go to 100% for a three minutes. This is to heat up the pads prior to placement on a patient. The activation of the switch is interpreted as a demand for 41° C. and if this temperature is not confirmed the unit will heat up to 38° C.

The MMC controls the temperature using a PID control loop. The actual temperature is measured using the temperature sensor 572 embedded in the pad. The SMC monitors the pad temperature using the other temperature sensor 574.

A two color LED on the control unit next to the LCD in the front facing section of the connection box will flash red and green and is used to provide status information.

TABLE II

| LED | Information |
|---|---|
| Green flashing | Heating up to target |
| Green continuous | Target reached |
| Red flashing | Over temperature, when actual is |
| | above target but not above 42° C. |
| Red continuous | Fault, heating and stimulation |
| | disabled. This could be temperature |
| | above 42° C. or a hardware fault. |

As shown in FIG. 9, after performing self-tests (634) the SMC 402 measures the safety temperature via the second sensor 574 (640) and disables the associated pad 50 if the specified maximum temperature is reached or exceeded (648).

Thus, the present invention has been described herein with reference to a particular embodiment for a particular application. Those having ordinary skill in the art and access to the present teachings will recognize additional modifications, applications and embodiments within the scope thereof. For example:

1. One or more pads may contain galvanic skin response (GSR) sensors in addition to the temperature sensors.

2. The GSR sensors will measure skin conductivity and provide readings to the inline control unit.

3. The inline control unit may pass these GSR readings to the central device console (e.g. cTEMS system) which may use the GSR readings in the treatment of dermatological conditions, or for relaxing and desensitization training.

4. One or more pads may contain Electromyography (EMG) sensors to measure electrical activity given off by the patient's muscles.

5. The EMG readings would be provided to the pad's inline control unit.

6. The EMG readings may be displayed on the LCD display of the inline control unit or the central device (cTEMS system).

7. The inline control unit may adjust the heat and/or stimulation levels based on the values from the EMG readings.

8. The inline control unit will provide the EMG readings to the cTEMS system.

9. The cTEMS system may adjust the heat and/or stimulation levels to each pad based on the EMG readings.

10. The EMG readings may be used in the treatment of patients who have symptoms of weakness and/or impaired muscle strength.

11. The EMG readings may be used in muscle strength and conditioning.

12. The EMG readings may be used in gait analysis.

13. The pad may contain a pulse sensor to measure the patient's heart rate.

14. The pulse sensor will pass readings back to the inline control unit.

15. The inline control unit may display the individual pad's pulse rate on the control unit's LCD display.

16. The inline control unit may pass the pulse rate back to the central device (cTEMS system).

17. Each inline control unit may communicate with other inline control units.

18. Each inline control unit may include wireless features to allow communication with other external devices and/or other inline control units.

It is therefore intended by the appended claims to cover any and all such applications, modifications and embodiments within the scope of the present invention.

Accordingly,

What is claimed is:

1. A controller for use in a therapeutic system having a console disposed in a first housing and a physically separate pad, said controller comprising:
a second housing physically separate from said console and said pad;
a processor disposed within said housing and electrically coupled to said console and said pad;
a storage medium accessible by said processor and mounted within said second housing;
software stored on said storage medium for execution by said processor;
a switch coupled to said processor; and
a display coupled to said processor.

2. The invention of claim 1 further including a second processor disposed within said second housing and electrically coupled to said console and said pad.

3. The invention of claim 1 wherein said switch is mounted on said second housing.

4. The invention of claim 1 wherein said display is mounted at least partially within said second housing.

5. The invention of claim 1 wherein said software includes code for applying a stimulation current to said pad.

6. The invention of claim 1 wherein said software includes code for regulating heat current applied to said pad.

7. The invention of claim 1 wherein said software includes code for sensing temperature from said pad

8. The invention of claim 7 wherein said software includes code for adjusting current to said pad in response to said sensed temperature at said pad.

9. The invention of claim 8 wherein said software includes code for adjusting current to said pad in response to said sensed temperature at said pad and a reference temperature data from said console.

10. The invention of claim 7 wherein said software includes code for sending data regarding said sensed temperature to said console.

11. The invention of claim 1 wherein said software includes code for sending status information to said console.

12. The invention of claim 1 wherein said software includes code for fault checking.

13. A thermostimulation system comprising:
a console disposed in a first housing;
a plurality of thermostimulation pads; and
a plurality of inline controllers electrically coupled between said console and a respective one of said pads, each of said controllers including:
a processor disposed within a second housing and electrically coupled to said console and said pad;
a storage medium accessible by said processor and mounted within said second housing; and
software stored on said storage medium for execution by said processor.

14. The invention of claim 13 wherein each of said controllers includes a switch.

15. The invention of claim 13 wherein each of said controllers includes a display.

16. The invention of claim 13 wherein each of said controllers further includes a second processor disposed within said housing and electrically coupled to said console and said pad.

17. The invention of claim 13 wherein said software includes code for applying a stimulation current to said pad.

18. The invention of claim 13 wherein said software includes code for regulating heat current applied to said pad.

19. The invention of claim 18 wherein said software includes code for sensing temperature from said pad.

20. The invention of claim 19 wherein said software includes code for adjusting current to said pad in response to said sensed temperature at said pad.

21. The invention of claim 20 wherein said software includes code for adjusting current to said pad in response to said sensed temperature at said pad and a reference temperature data from said console.

22. The invention of claim 19 wherein said pad includes code for sending data regarding said sensed temperature to said console.

23. The invention of claim 13 wherein said software includes code for sending status information to said console.

24. A method for regulating heat current to a therapeutic pad including the steps of:
providing an inline controller between a console and said pad, said controller having:
a processor disposed within a second housing and electrically coupled to said console and said pad;
a storage medium accessible by said processor and mounted within said second housing; and
software stored on said storage medium for execution by said processor;
providing a temperature or heat level setting at said console; and
regulating heat current to said pad via said inline controller.
